(19) United States
(12) Patent Application Publication
(10) Pub. No.: US 2025/0150358 A1
(43) Pub. Date: May 8, 2025

(54) IMAGE PROCESSING APPARATUS, CONTROL METHOD, AND NON-TRANSITORY COMPUTER-READABLE RECORDING MEDIUM

(71) Applicant: Konica Minolta, Inc., Tokyo (JP)

(72) Inventor: Takashi Sugaya, Tokyo (JP)

(73) Assignee: Konica Minolta, Inc., Tokyo (JP)

(21) Appl. No.: 18/922,843

(22) Filed: Oct. 22, 2024

(30) Foreign Application Priority Data
Nov. 6, 2023 (JP) 2023-189028

(51) Int. Cl. H04L 41/00; G06F 16/958; H04L 67/02

(52) U.S. Cl. CPC H04L 41/24; G06F 16/972; H04L 67/02

(57) ABSTRACT

An image processing apparatus includes a hardware processor that: causes a web browser that manage account information for login to a cloud server to function; transmits and receives data required for execution of a job to or from a cloud server, when the web browser is logged in to the cloud server by using the account information; and controls the account information managed by the web browser of an old version to be usable by the web browser of a new version, when the version of the web browser is changed.

### CROSS REFERENCE TO RELATED APPLICATIONS

This application is based on Japanese Patent Application No. 2023-189028 filed on Nov. 6, 2023, the contents of which are incorporated herein by reference.

### BACKGROUND OF THE INVENTION

### Technical Field

The present invention relates to an image processing apparatus, a control method, and a non-transitory computer-readable recording medium.

### Description of Related Art

Cloud services such as Google (R) drives and OneDrive (R) are becoming popular. These cloud services store user's necessary data in a server on the cloud. Therefore, a user can use data anytime and anywhere by accessing a cloud server that provides a cloud service.

In recent years, an application that cooperates with a cloud server is also installed on an image processing apparatus such as an MFP (Multifunction Peripheral) installed in an office or the like. Therefore, the image processing apparatus can store necessary data in the cloud server or acquire necessary data from the cloud server in accordance with execution of a job. For example, the image processing apparatus can upload image data of a document generated by a scan job to the cloud server and store the image data therein. The image processing apparatus can also acquire image data to be printed from a cloud server, execute a print job, and print out the image data.

For example, a cooperative application that cooperates with the cloud server accesses the cloud server by using a function of a web browser installed in the image processing apparatus. In this case, the web browser manages account information for login to the cloud server as cookie information (e.g., Japanese Patent Literature No. JP2014-164376A). Therefore, when the user logs in to the cloud server for the first time, the cooperation application receives input of account information by the user. When the account information is input by the user, the cooperation application passes the account information to the web browser. The web browser accesses the cloud server using the account information. When the web browser can log in to the cloud server, the web browser stores the account information in the cookie information. At this time, the web browser stores, as cookie information, user information on the user who has logged in to the image processing apparatus and the account information for the user to log in to the cloud server in association with each other. When accessing the cloud server, the cooperative application designates the user information of the user who has logged in to the image processing apparatus and instructs the web browser to access the cloud server. Thus, the web browser can read the cookie information including the account information associated with the specified user information, and automatically log in to the cloud server. That is, single sign-on (SSO) authentication when the image processing apparatus accesses the cloud server is implemented.

Incidentally, the web browser installed in the image processing apparatus is configured with open source software (OSS) such as Python or Node. js. The web browser configured with open source software can be improved or modified by anyone freely removing a bug. For this reason, the web browser installed in the image processing apparatus may be upgraded by improving or correcting the source code.

However, with the upgrade of the web browser installed in the image processing apparatus, the storage area of the cookie information managed by the web browser and the reading processing when the web browser reads the cookie information may be changed. When the storage area and the reading processing of the cookie information are changed, the web browser of the new version cannot use the cookie information used by the web browser of the old version. Therefore, the cooperation application cannot automatically log in to the cloud server. As a result, the user has to manually input the account information again, which reduces convenience.

### SUMMARY OF THE INVENTION

The present invention provides an image processing apparatus, a control method, and a non-transitory computer-readable recording medium that solve the above-described conventional problems. That is, an object of the present invention is to enable account information managed by an old version of a Web browser to be continuously used when the version of the Web browser is changed.

In order to achieve the above objects, firstly, the present invention is directed to an image forming apparatus.

In one aspect of the present invention, the image processing apparatus includes a hardware processor that: causes a web browser that manage account information for login to a cloud server to function; transmits and receives data required for execution of a job to or from a cloud server, when the web browser is logged in to the cloud server by using the account information; and controls the account information managed by the web browser of an old version to be usable by the web browser of a new version, when the version of the web browser is changed.

Secondly, the present invention is directed to a control method performed in an image processing apparatus including a web browser that manages account information for login to a cloud server. The image processing apparatus transmits and receives data required for execution of a job to and from the cloud server in a state where the Web browser is login to the cloud server using the account information.

In one aspect of the present invention, the control method includes: detecting that a version of the web browser has changed; and controlling the account information managed by the web browser of an old version to be usable by the web browser of a new version, when it is detected that the version of the web browser is changed.

Thirdly, the present invention is directed to a non-transitory computer-readable recording medium storing a program to be executed in an image processing apparatus comprising a web browser that manages account information for login to a cloud server. The image processing apparatus transmits and receives data required for execution of a job to and from the cloud server while the web browser is login to the cloud server using the account information.

In one aspect of the present invention, the program causes the image processing apparatus to perform: detecting a version of the web browser has changed; and controlling the account information managed by the web browser of an old version to be usable by the web browser of a new version, when it is detected that the version of the web browser is changed.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an example of a conceptual configuration of a network system including an image processing apparatus;

FIG. 2 is a block diagram illustrating an example of a hardware configuration of an image processing apparatus;

FIG. 3 is a block diagram illustrating an example of a functional configuration of a controller;

FIG. 4 is a block diagram illustrating an example of a functional configuration of the controller when the Web browser is changed to a new version;

FIG. 5 illustrates an example of control by the adaptive controller;

FIG. 6 is a flowchart illustrating an example of a main processing procedure performed in the image processing apparatus; and

FIG. 7 is a flowchart illustrating a detailed processing procedure of automatic login processing.

### DETAILED DESCRIPTION OF THE EMBODIMENTS

Hereinafter, one or more embodiments of the present invention will be described with reference to the drawings. However, the scope of the invention is not limited to the disclosed embodiments.

Hereinafter, preferred embodiments of the present invention will be described in detail with reference to the drawings. Note that elements common to the embodiments described below are denoted by the same reference signs, and redundant description thereof is omitted.

### Preferred Embodiments

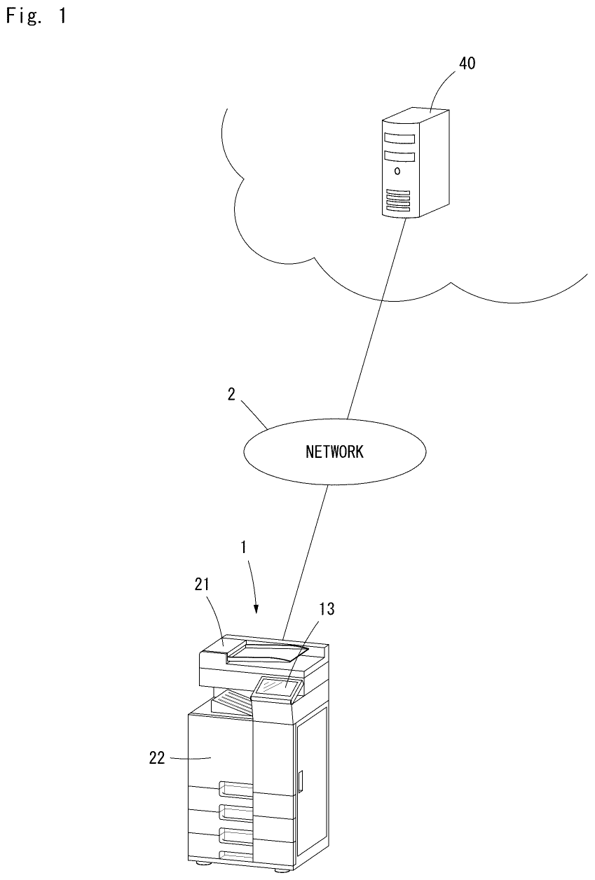

FIG. 1 illustrates a conceptual configuration example of a network system including an image processing apparatus 1 according to an embodiment of the present invention. The network system includes an image processing apparatus 1, a network 2, and a cloud server 40. The network 2 is a communication network that includes a local network such as a local area network (LAN) and a wide area network such as the Internet. The cloud server 40 is installed on a cloud such as the Internet and provides various cloud services. For example, the cloud server 40 provides a storage service for storing data necessary for a user on the cloud.

The image processing apparatus 1 is configured as, for example, an MFP. The image processing apparatus 1 has multiple functions such as a scan function, a print function, a copy function, and a FAX function, and executes a job designated by a user. The image processing apparatus 1 includes a scanner section 21 at an upper part of the apparatus main body. The scanner section 21 generates image data by optically reading a document set by a user. Further, the image processing apparatus 1 includes a printer section 22 in a lower part of the apparatus main body. The printer section 22 forms an image on a sheet such as printing paper based on image data to be printed, and outputs the sheet.

The image processing apparatus 1 includes an operation panel 13 functioning as a user interface on the front side of the apparatus main body. The operation panel 13 displays various operation screens that can be operated by a user, and receives input operation from the user. For example, when authentication information such as a user ID and a password is input to the operation panel 13, the image processing apparatus 1 performs user authentication. If the user can be specified in the user authentication, the image processing apparatus 1 shifts the operation state from the logout state to the login state. By shifting to the login state, the image processing apparatus 1 enters a state in which the image processing apparatus 1 can receive a job setting operation and an execution from the login user. The image processing apparatus 1 executes a job such as a scan job, a print job, or a copy job based on an instruction operation by a login user.

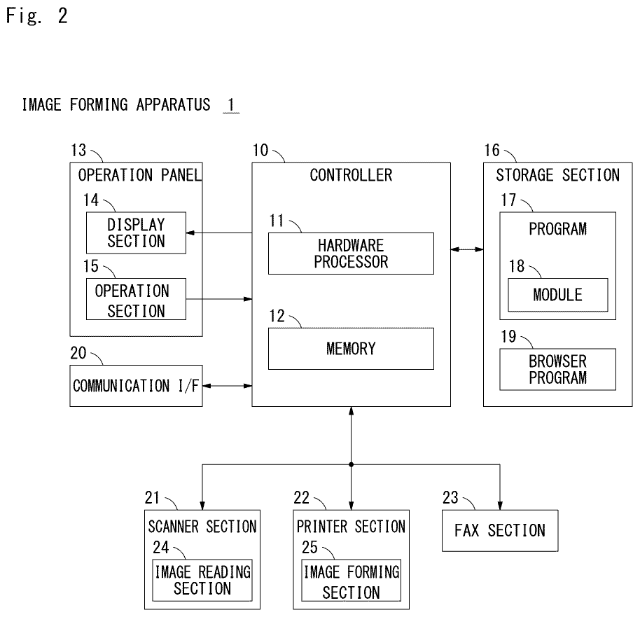

FIG. 2 is a block diagram illustrating an example of a hardware configuration of the image processing apparatus 1. The image processing apparatus 1 includes, as the hardware configuration, a controller 10, an operation panel 13, a storage section 16, a communication interface 20, a scanner section 21, a printer section 22, and a FAX section 23.

The controller 10 comprehensively controls the operation of the image processing apparatus 1. The controller 10 includes a hardware processor 11 and a memory 12. The hardware processor 11 reads and executes various programs stored in the storage section 16. The memory 12 is a volatile storage device that stores temporary data generated along with the execution of the program by the hardware processor 11.

The operation panel 13 includes a display section 14 and an operation section 15. The display section 14 is formed with, for example, a color liquid crystal display, and displays various operation screens that can be operated by a user. The operation section 15 includes, for example, touch screen keys arranged on the screen of the display section 14, and receives an operation by the user.

The storage section 16 is a non-volatile storage device including a hard disk drive (HDD), a solid state drive (SSD), or the like. The storage section 16 stores a program 17 and a browser program 19. The browser program 19 is a program that causes a web browser to function. The program 17 is a program for causing the operation panel 13 and a web browser to cooperate with each other and causing an application 30 for executing a job specified by a user to function. The program 17 includes a program module 18 formed with a JavaScript or the like. The program module 18 outputs various commands to the web browser.

The communication interface 20 connects the image processing apparatus 1 to the network 2. The communication interface 20 is an interface for the image processing apparatus 1 to communicate via the network 2.

The scanner section 21 includes an image reading section 24. The image reading section 24 generates image data by irradiating an image reading surface of a document with light and reading light reflected from the document for each pixel.

The printer section 22 includes an image forming section 25. The image forming section 25 forms and outputs an image on a sheet by, for example, an electrophotographic method. However, the image forming method by the image forming section 25 is not limited to the electrophotographic method. For example, the image forming section 25 may form an image by an inkjet method.

The FAX section 23 is a section that performs FAX data transmission and reception via a public switched telephone network (not illustrated).

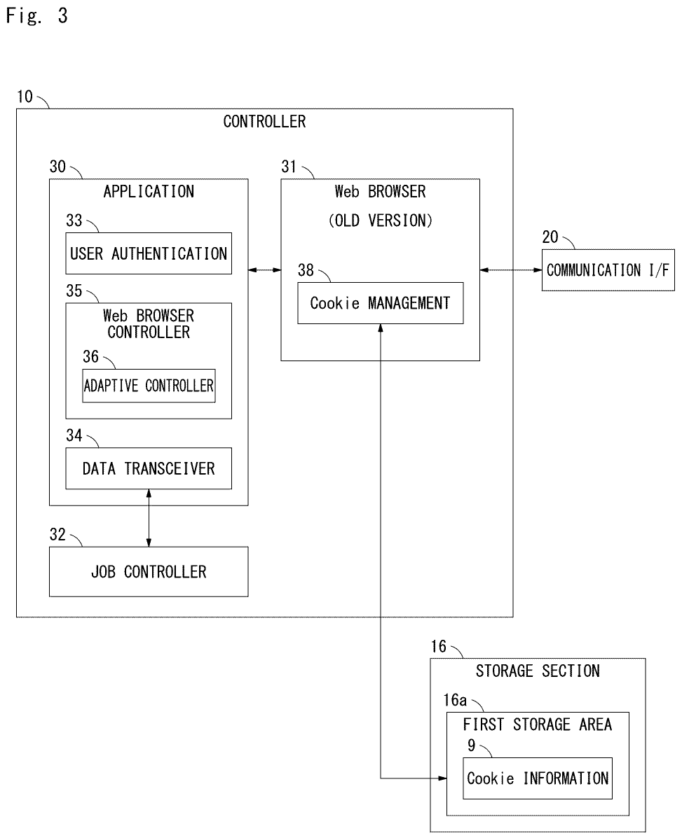

FIG. 3 is a block diagram illustrating an example of a functional configuration of the controller 10. When the hardware processor 11 executes various programs, the controller 10 functions as an application 30, a web browser 31, and a job controller 32.

The application 30 cooperates with the operation panel 13 to perform processing based on a user's instruction operation. When the execution of a job is instructed by a user, the application 30 operates the job controller 32 to instruct the execution of the job specified by the user. Furthermore, the application 30 can cause the web browser 31 and the job controller 32 to operate in cooperation with each other. For example, when it is specified to upload image data generated by a scan job to the cloud server 40, the application 30 causes the job controller 32 to execute the scan job. Next, the application 30 acquires the image data output from the job controller 32, and uploads the image data to the cloud server 40 via the web browser 31. Furthermore, for example, when it is specified to download image data stored in the cloud server 40 and perform a print job, the application 30 downloads the image data from the cloud server 40 via the web browser 31. The application 30 then outputs the image data acquired from the cloud server 40 to the job controller 32 to execute the print job.

The application 30 includes a user authentication section 33, a data transceiver 34, and a web browser controller 35.

The user authentication section 33 performs user authentication based on authentication information input by the user. When the user authentication is successful and the user can be specified, the application 30 shifts the operating state of the image processing apparatus 1 to the login state. When the image processing apparatus 1 shifts to the login state, the user authentication section 33 holds user information on the login user.

The data transceiver 34 transmits and receives data to and from the cloud server 40 via the web browser 31.

The web browser controller 35 controls the web browser 31. The web browser controller 35 activates the web browser 31. Then, the web browser controller 35 causes the web browser 31 to access the cloud server 40. When the login user accesses the cloud server 40 for the first time, the web browser 31 acquires a login screen for login to the cloud server 40. The web browser controller 35 displays the login screen acquired by the web browser 31 on the display section 14 of the operation panel 13. Then, the web browser controller 35 receives an input of account information by the login user. The account information is authentication information for the login user to log in to the cloud server 40, and is information including, for example, a user ID and a password. When the account information is input by the login user, the web browser controller 35 outputs the account information to the web browser 31. Thus, the web browser 31 logs in to the cloud server 40 using the account information input by the login user. As a result, the application 30 becomes ready to transmit/receive data necessary for executing the job to/from the cloud server 40 via the web browser 31.

When succeeding in login to the cloud server 40, the web browser controller 35 allows the web browser 31 to manage the cookie information 9 including the account information. The web browser 31 includes a cookie management section 38. The cookie management section 38 stores, in the cookie information 9, account information used for login to the cloud server 40, and manages the account information. For example, the cookie management section 38 stores and manages the cookie information 9 in the first storage area 16a of the storage section 16. Furthermore, the cookie management section 38 stores the cookie information 9 in a state of being associated with user information on the login user. Therefore, when the login user who uses the image processing apparatus 1 is specified, the cookie management section 38 can automatically read the cookie information 9 for the user to access the cloud server 40.

When the same login user logs in to the cloud server 40 for the second time or later, the web browser controller 35 uses the cookie information 9 managed by the web browser 31. That is, the web browser controller 35 instructs the web browser 31 to log in to the cloud server 40 by using the cookie information 9. Thus, the web browser 31 reads the cookie information 9 associated with the login user from the storage section 16, and accesses the cloud server 40 to automatically log in. At this time, the login user does not need to manually input account information such as a user ID and a password again. That is, if the image processing apparatus 1 can specify the user in the user authentication, the image processing apparatus 1 can automatically log in to the cloud server 40 using the cookie information 9. Therefore, single sign-on authentication is realized in the image processing apparatus 1, and an operation burden on the user is reduced.

The browser program 19 that causes the web browser 31 to function in the image processing apparatus 1 is configured by, for example, open source software (OSS). Therefore, the browser program 19 may be upgraded due to improvement or modification of the source code. The image processing apparatus 1 periodically or non-periodically monitors whether the version of the browser program 19 stored in the storage section 16 is updated. When the version has been updated, the image processing apparatus 1 automatically acquires the browser program 19 of the latest version and automatically updates the browser program 19 in the storage section 16. Therefore, the version of the web browser 31 activated in the image processing apparatus 1 may be updated.

When the version of the web browser 31 is updated, the cookie information 9 used by the web browser 31 of the old version may not be used by the web browser 31 of the new version.

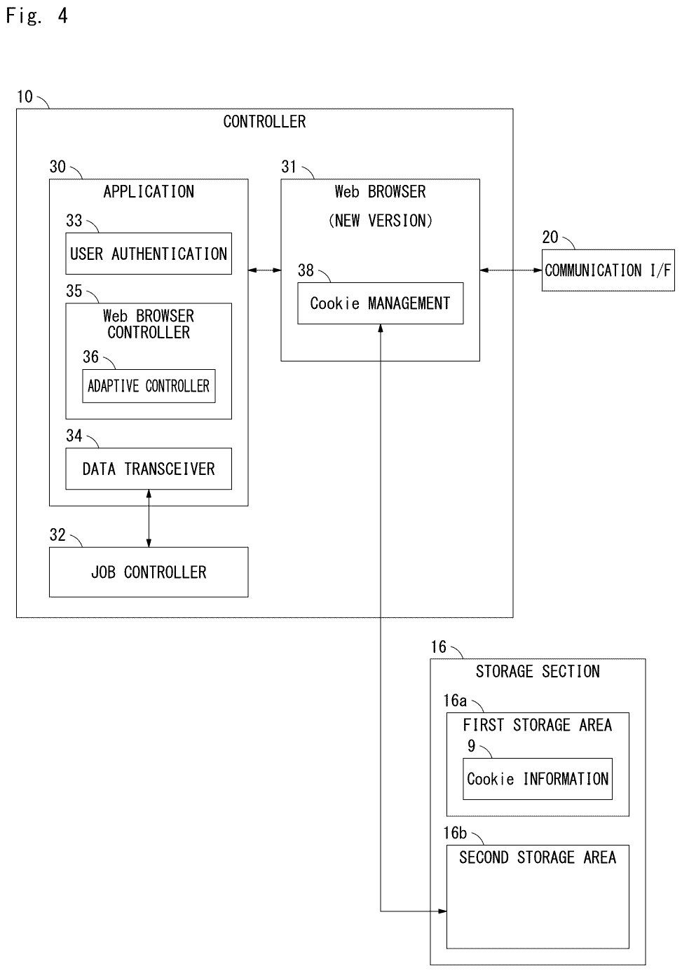

FIG. 4 is a block diagram illustrating an example of a functional configuration of the controller 10 when the web browser 31 is changed to a new version. In the example illustrated in FIG. 4, the storage area accessed by the new version web browser 31 to store or read the cookie information 9 is changed to the second storage area 16b of the storage section 16. In this case, even if the web browser controller 35 instructs the web browser 31 to log in to the cloud server 40 using the cookie information 9, the web browser 31 of the new version cannot read the cookie information 9. Therefore, the new version web browser 31 is not allowed to automatically log in to the cloud server 40.

The web browser 31 of the new version may not be able to automatically log in to the cloud server 40 even when the storage area for storing or reading the cookie information 9 is not changed from that of the old version. For example, an application programming interface (API) for causing the web browser 31 of the new version to read the cookie information 9 may be changed from the web browser 31 of the old version. In this case, the web browser controller 35 outputs the read instruction for reading the cookie information 9 in the same format as that of the old version. However, since the API of the web browser 31 of the new version has been changed. the web browser 31 cannot interpret the command from the web browser controller 35 and does not read the cookie information 9. As a result, the new version web browser 31 is not allowed to automatically log in to the cloud server 40.

Further, in the web browser 31 of the new version, a library used when the account information included in the cookie information 9 is encrypted or decrypted may be changed. In this case, even if the web browser 31 of the new version decrypts the encrypted account information included in the Cookie information 9, the web browser 31 cannot accurately restore the account information. As a result, the new version web browser 31 is not allowed to automatically log in to the cloud server 40.

Therefore, the web browser controller 35 includes an adaptive controller 36. The adaptive controller 36 functions when the web browser 31 has been changed from the old version to the new version. The adaptive controller 36 performs controller so that the web browser 31 of the new version can automatically log in to the cloud server 40 using the account information included in the cookie information 9 managed by the web browser 31 of the old version.

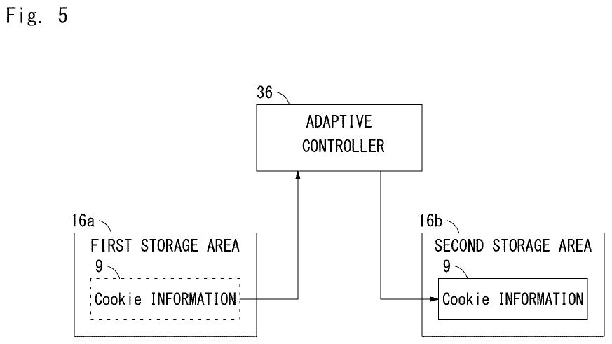

FIG. 5 illustrates an example of control by the adaptive controller 36. FIG. 5 illustrates a case where the storage area accessed by the web browser 31 of the new version to store or read the cookie information 9 is changed from the storage area of the old version. In this case, the adaptive controller 36 reads the cookie information 9 from the first storage area 16a accessed by the web browser 31 of the old version, and stores the cookie information 9 in the second storage area 16b accessed by the web browser 31 of the new version. At this time, the adaptive controller 36 preferably deletes the cookie information 9 stored in the first storage area 16a. Since the cookie information 9 is transferred to the second storage area 16b by the adaptive controller 36, the web browser 31 of the new version can normally read and acquire the cookie information 9 from the second storage area 16b. Therefore, the web browser 31 of the new version can automatically log in to the cloud server 40 using the cookie information 9 that has been used by the web browser 31 of the old version.

When the API for reading the cookie information 9 in the web browser 31 of the new version is changed from the API of the old version, the adaptive controller 36 performs control to adapt to this change. That is, the adaptive controller 36 changes the processing of outputting the instruction to read the cookie information 9 so that the instruction adapted to the changed API can be output. Specifically, the adaptive controller 36 changes the processing of outputting the read instruction by rewriting the program module 18 used when outputting the read instruction for reading the cookie information 9 or changing the program module 18 to another program module 18. For example, when the API is changed, a necessary argument may be added to a command at the time of API call for causing the web browser 31 to read the cookie information 9. In such a case, the adaptive controller 36 can add an argument included in the read instruction of the cookie information 9 by changing the process of outputting the read instruction of the cookie information 9. As a result, the web browser controller 35 can output a command interpretable by the web browser 31 of the new version. As a result, the new version web browser 31 can automatically log in to the cloud server 40 using the cookie information 9 that has been used by the old version web browser 31, based on an instruction from the web browser controller 35.

Further, when the library used for encryption or decryption the account information included in the cookie information 9 is changed in the web browser 31 of the new version, the adaptive controller 36 performs control to adapt to the change. That is, the adaptive controller 36 rewrites the library used by the web browser 31 of the new version at the time of encryption or decryption, and changes the encryption or decryption processing. When the encryption or decryption processing is changed by the adaptive controller 36, the new version web browser 31 encrypts or decrypts the account information by using the library rewritten by the adaptive controller 36. As a result, the new version web browser 31 can accurately decrypt the encrypted account information included in the cookie information 9, and can automatically log in to the cloud server 40 using the account information.

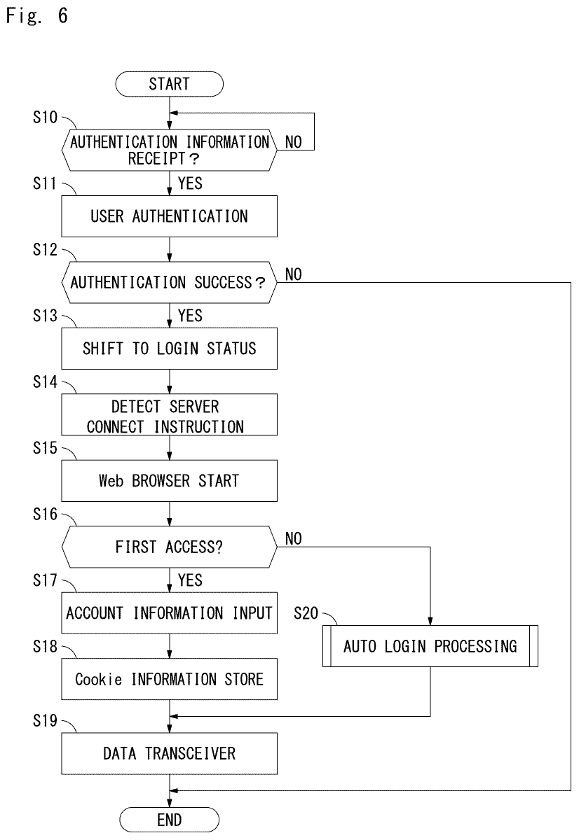

Next, the operation of the image processing apparatus 1 will be described. FIG. 6 is a flowchart illustrating an example of a processing procedure performed in the image processing apparatus 1. This processing procedure is performed by the hardware processor 11 executing the program 17. More specifically, processing based on the flowchart illustrated in FIG. 6 is mainly performed by the application 30 of the controller 10.

When starting this processing, the application 30 first brings the user authentication section 33 into operation. The user authentication section 33 waits until it receives authentication information entered by the user (step S10). When authentication information is input by the user (YES in step S10), the user authentication section 33 performs user authentication (step S11). The user authentication section 33 determines whether the user authentication has succeeded (step S12). If the user authentication has failed (NO in step S12), the processing by the image processing apparatus l ends. On the other hand, when the user authentication is successful (YES in step S12), the user authentication section 33 shifts the operation state to the login state (step S13). At this time, the user authentication section 33 specifies the login user based on the result of the user authentication.

Next, the application 30 receives an instruction to connect to the cloud server 40 from the login user (step S14). Upon receiving the instruction to connect to the cloud server 40, the application 30 brings the web browser controller 35 into operation.

The web browser controller 35 activates the web browser 31 in the controller 10 (step S15). The web browser controller 35 determines whether or not the access to the cloud server 40 by the login user is the first access (step S16).

If the access is the first access (YES in step S16), the web browser controller 35 accepts an input operation of account information by the login user, and logs in to the cloud server 40 via the web browser 31 (step S17). If the login to the cloud server 40 is successful, the web browser controller 35 causes the web browser 31 to store the cookie information 9 including the account information (step S18). At this time, the web browser controller 35 notifies the web browser 31 of the user information about the login user. Therefore, the web browser 31 stores the cookie information 9 in the first storage area 16a in association with the login user. Thus, the account information for each user for login to the cloud server 40 is managed as the cookie information 9 by the web browser 31. When the login to the cloud server 40 is successful, the application 30 becomes able to transmit data to and receive data from the cloud server 40 via the web browser 31.

On the other hand, when the access to the cloud server 40 by the login user is not the first access (NO in step S16), the web browser controller 35 executes an automatic login processing (step S20). That is, the web browser controller 35 executes processing for automatically log in to the cloud server 40 using the account information included in the cookie information 9 managed by the web browser 31.

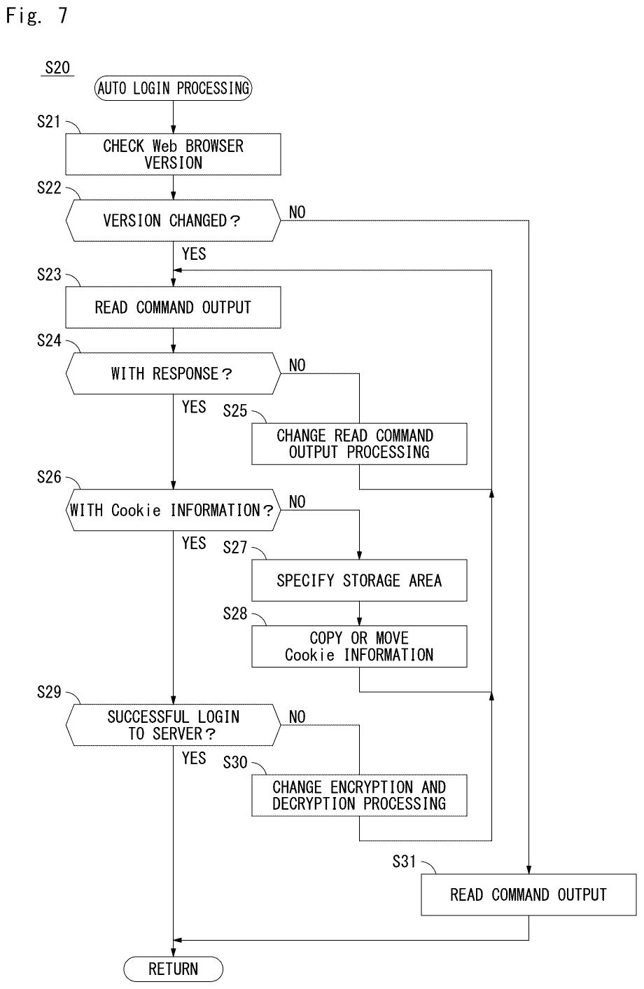

FIG. 7 is a flowchart illustrating a detailed processing procedure of automatic login processing (step S20). When starting the automatic login processing, the web browser controller 35 first checks the version of the web browser 31 (step S21). The web browser controller 35 determines whether or not the version of the web browser 31 has changed from the version at the time of the last activation (step S22).

If the version of the web browser 31 has been changed (YES in step S22), the web browser controller 35 outputs a command to read the cookie information 9 in the same format as the command output to the web browser 31 of the old version (step S23). That is, the same command as that of the old version is output to the web browser 31 of the new version. At this time, the web browser controller 35 gives an instruction to read the cookie information 9 associated with the login user.

Thereafter, the web browser controller 35 determines whether or not there is a response to the read command from the web browser 31 of the new version (step S24). When there is a response from the web browser 31 of the new version (YES in step S24), the web browser 31 of the new version can interpret the read command. On the other hand, when there is no response from the web browser 31 of the new version (NO in step S24), the web browser 31 cannot interpret the read command.

When there is no response from the web browser 31 (NO in step S24), the web browser controller 35 brings the adaptive controller 36 into operation. The adaptive controller 36 changes the processing of outputting the instruction to read the cookie information 9 (step S25). As a result, the web browser controller 35 can output a read command interpretable by the web browser 31 of the new version. When the processing of outputting the read command is changed by the adaptive controller 36, the web browser controller 35 executes the processing of step S23 again. At this time, since the new version web browser 31 can normally interpret the read command from the web browser controller 35, the new version web browser 31 outputs a response to the web browser controller 35 and performs a processing of reading the cookie information 9.

If there is a response from the web browser 31 (YES in step S24), the web browser controller 35 determines whether or not the web browser 31 has normally read the cookie information 9 (step S26).

If the web browser 31 of the new version cannot read the cookie information 9 (NO in step S26), it means that the cookie information 9 is not stored in the storage area accessed by the web browser 31. In this case, the web browser controller 35 brings the adaptive controller 36 into operation. The adaptive controller 36 specifies the first storage area 16a in which the web browser 31 of the old version stores the cookie information 9 and the second storage area 16b to be accessed by the web browser 31 of the new version (step S27). Upon specifying the first storage area 16a and the second storage area 16b. the adaptive controller 36 copies or moves the cookie information 9 stored in the first storage area 16a to the second storage area 16b (step S28). When the cookie information 9 is stored in the second storage area 16b by the adaptive controller 36, the web browser controller 35 executes the processing in step S23 and subsequent steps again. At this time, the new version web browser 31 can normally read the cookie information 9 from the second storage area 16b. Then, the web browser 31 of the new version executes a processing for login to the cloud server 40 by using the account information included in the cookie information 9 read from the second storage area 16b.

When the web browser 31 of the new version can normally read the cookie information 9 (YES in step S26), the web browser controller 35 determines whether or not the login to the cloud server 40 is successful (step S29).

If the login to the cloud server 40 has failed (NO in step S29), the web browser controller 35 determines that the encryption or decryption of the account information included in the cookie information 9 has failed. In this case, the web browser controller 35 brings the adaptive controller 36 into operation. The adaptive controller 36 changes the encryption or decryption processing used when the new version web browser 31 encrypts or decrypts the account information included in the cookie information 9. For example, the adaptive controller 36 rewrites a library used by the web browser 31 of the new version at the time of encryption or decryption, and changes encryption or decryption processing. When the encryption or decryption processing is changed by the adaptive controller 36, the new version web browser 31 encrypts or decrypts the account information by using the library rewritten by the adaptive controller 36. Therefore, the new version web browser 31 can accurately decrypt the encrypted account information included in the cookie information 9.

When the encryption or decryption processing is changed by the adaptive controller 36, the web browser controller 35 executes the processing in step S23 and subsequent steps again. At this time, the web browser 31 of the new version decrypts the account information included in the cookie information 9 by the changed decryption processing. Then, the new version web browser 31 executes a processing for login to the cloud server 40 by using the decrypted account information. In this case, since the account information has been normally decrypted, the web browser 31 of the new version can automatically log in to the cloud server 40 by using the account information used by the web browser 31 of the old version (YES in step S29).

On the other hand, if the version of the web browser 31 has not changed from the version at the time of the previous activation (NO in step S22), the web browser controller 35 outputs a command to read the cookie information 9 to the web browser 31 as before (step S31). At this time, the web browser controller 35 gives an instruction to read the cookie information 9 associated with the login user. When the version of the web browser 31 is not changed, the web browser 31 can normally read the cookie information 9. Therefore, the web browser 31 can automatically log in to the cloud server 40 using the account information included in the cookie information 9. Thus, the automatic login processing ends.

When the automatic login to the cloud server 40 is successful by the automatic login processing (step S20), the application 30 becomes ready for data transmission and reception to and from the cloud server 40 via the web browser 31.

Thereafter, the application 30 causes the data transceiver 34 to function. The data transceiver 34 transmits and receives data necessary for executing a job to and from the cloud server 40 via the web browser 31. For example, when image data to be printed is acquired from the cloud server 40, the data transceiver 34 outputs the image data to the job controller 32. Thus, the image processing apparatus 1 executes the print job based on the image data acquired from the cloud server 40. Furthermore, when image data generated by a scan job is acquired from the job controller 32, the data transceiver 34 transmits and uploads the image data to the cloud server 40. Thus, the image processing apparatus 1 can automatically upload the image data to the cloud server 40 as a series of operations in the scan job.

As described above, the image processing apparatus 1 of the present embodiment causes the hardware processor 11 to function as the web browser 31, the data transceiver 34, and the web browser controller 35. The web browser 31 manages account information for login to the cloud server 40. Furthermore, when the web browser 31 is logged in to the cloud server 40 using account information, the data transceiver 34 transmits and receives data required for execution of a job to and from the cloud server 40. When the version of the web browser 31 is changed, the web browser controller 35 performs control so that the account information managed by the web browser 31 of the old version can be used by the web browser 31 of the new version. Therefore, when the version of the web browser 31 is changed, the image processing apparatus 1 according to the present embodiment can continuously use the account information managed by the web browser 31 of the old version in the web browser 31 of the new version. Therefore, even when the version of the web browser 31 is changed, the user does not need to manually input the account information for login to the cloud server 40 again.

### Modification Example

Hereinabove, a preferred embodiment of the present invention has been described. However, the present invention is not limited to the content described in the above embodiment. That is, various modification examples can be applied to the present invention with respect to the above described embodiment.

For example, the web browser controller 35 may be configured to store the cookie information 9 managed by the web browser 31 in an external storage device as a backup. In this case, the external storage device is, for example, a storage device provided in a local network such as a LAN to which the image processing apparatus 1 is connected. Further, the external storage device may be a cloud storage installed on a cloud. In this case, when the version of the web browser 31 is changed, the web browser controller 35 can acquire the cookie information 9 from the external storage device and store the cookie information 9 in a storage area accessed by the web browser 31 of the new version. For example, at the time of version upgrade of the web browser 31, the cookie information 9 may be deleted from the first storage area 16a managed by the web browser 31 of an old version. Even when the cookie information 9 is deleted from the first storage area 16a at the time of version upgrade, the web browser controller 35 can restore the cookie information 9 from the external storage device. Therefore, the web browser 31 of the new version can continuously use the previous cookie information 9.

For example, when the web browser controller 35 copies or moves the cookie information 9 stored in the first storage area 16a to the second storage area 16b. the web browser controller 35 stores the cookie information 9 in an external storage device as a backup. As a result, the web browser controller 35 can restore the cookie information 9 from the external storage device at the time of subsequent version upgrade or downgrade.

Further, in the above described embodiment, the case where the image processing apparatus 1 is configured as an MFP and is an apparatus having multiple functions such as a scan function, a print function, a copy function, and a FAX function has been exemplified. However, the image processing apparatus 1 is not limited to an apparatus configured as an MFP. That is, the image processing apparatus 1 may be any apparatus in which the web browser 31 is installed.

Furthermore, the case where the program 17 described in the above embodiment is stored in advance in the image processing apparatus 1 has been illustrated. However, the program 17 is not limited to a program stored in the image processing apparatus 1 in advance. For example, the program 17 can be a target of transaction by itself. In this case, the program 17 may be provided in a downloadable form to the image processing apparatus 1 via the network 2 such as the Internet. Further, the program 17 may be provided in a state of being recorded in a computer-readable recording medium such as a CD-ROM or a USB memory.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing apparatus comprising:
a hardware processor that:
causes a web browser that manage account information for login to a cloud server to function;
transmits and receives data required for execution of a job to or from a cloud server, when the web browser is logged in to the cloud server by using the account information; and
controls the account information managed by the web browser of an old version to be usable by the web browser of a new version, when the version of the web browser is changed.

2. The image processing apparatus according to claim 1, wherein
the account information is managed as cookie information by the web browser.

3. The image processing apparatus according to claim 2, wherein
when the version of the web browser is changed, the hardware processor stores the cookie information that has been stored in a first storage area by the web browser of the old version in a second storage area that the web browser of the new version accesses.

4. The image processing apparatus according to claim 3, wherein
the hardware processor further stores the cookie information in an external storage device when the version of the web browser is changed.

5. The image processing apparatus according to claim 2, wherein
when the version of the web browser is changed, the hardware processor outputs a read command of the cookie information to the web browser of the new version, and thereafter, when there is no response to the read command from the web browser of the new version, the hardware processor changes processing for outputting the read command.

6. The image processing apparatus according to claim 5, wherein
when there is a response to the read command from the web browser of the new version and the web browser of the new version cannot acquire the cookie information, the hardware processor stores the cookie information stored in a first storage area by the web browser of the old version in a second storage area accessed by the web browser of the new version.

7. The image processing apparatus according to claim 2, wherein
when the web browser of the new version can acquire the cookie information, the hardware processor changes encryption and decryption processing of the cookie information when the login to the cloud server fails.

8. A control method performed in an image processing apparatus including a web browser that manages account information for login to a cloud server, the image processing apparatus transmitting and receiving data required for execution of a job to and from the cloud server in a state where the Web browser is login to the cloud server using the account information, comprising:
detecting that a version of the web browser has changed; and
controlling the account information managed by the web browser of an old version to be usable by the web browser of a new version, when it is detected that the version of the web browser is changed.

9. The control method according to claim 8, wherein
the account information is managed as cookie information by the web browser.

10. The control method according to claim 9, further comprising:
when the version of the web browser is changed, storing the cookie information that has been stored in a first storage area by the web browser of the old version in a second storage area that the web browser of the new version accesses.

11. The control method according to claim 10, further comprising:
storing the cookie information in an external storage device when the version of the web browser is changed.

12. The control method according to claim 9, further comprising:
when the version of the web browser is changed, outputting a read command of the cookie information to the web browser of the new version; and
when there is no response to the read command from the web browser of the new version, changing processing for outputting the read command.

13. The control method according to claim 12, further comprising:
when there is a response to the read command from the web browser of the new version and the web browser of the new version cannot acquire the cookie information, storing the cookie information stored in a first storage area by the web browser of the old version in a second storage area accessed by the web browser of the new version.

14. The control method according to claim 9, further comprising:
when the web browser of the new version can acquire the cookie information, changing encryption and decryption processing of the cookie information when the login to the cloud server fails.

15. A non-transitory computer-readable recording medium storing a program to be executed in an image processing apparatus comprising a web browser that manages account information for login to a cloud server, the image processing apparatus transmitting and receiving data required for execution of a job to and from the cloud server while the web browser is login to the cloud server using the account information, wherein the program causes the image processing apparatus to perform:
detecting a version of the web browser has changed; and
controlling the account information managed by the web browser of an old version to be usable by the web browser of a new version, when it is detected that the version of the web browser is changed.
